(19) United States
(12) Patent Application Publication
(10) Pub. No.: US 2026/0139206 A1
(43) Pub. Date: May 21, 2026

(54) METHOD FOR CONDITIONING A LIGNOCELLULOSIC WOOD SUBSTRATE

(71) Applicant: Daniel Przemyslaw Idzkowski, San Ramon, CA (US)

(72) Inventor: Daniel Przemyslaw Idzkowski, San Ramon, CA (US)

(21) Appl. No.: 19/390,636

(22) Filed: Nov. 16, 2025

Related U.S. Application Data
(60) Provisional application No. 63/722,731, filed on Nov. 20, 2024.

(51) Int. Cl. C12G 3/07; B27K 3/34; B27K 5/00; C12C 11/11; C12G 1/00

(52) U.S. Cl. CPC C12G 3/07; B27K 3/34; B27K 5/0085; C12C 11/11; C12G 1/00; C12G 2200/21

(57) ABSTRACT

Methods, systems, and apparatus for conditioning lignocellulosic wood substrates used in the maturation of alcoholic beverages are disclosed. The methods include determining one or more chemical or structural properties of a wood substrate, applying at least one chemical, enzymatic, thermal, or physicochemical conditioning treatment effective to modify extractive composition, diffusion behavior, porosity, surface chemistry, or pH buffering capacity, and stabilizing the treated substrate under controlled environmental conditions. Conditioned substrates may be configured in various physical forms for controlled interaction with alcoholic beverages. Related systems incorporate conditioned substrates within containers holding alcoholic beverages to influence flavor development during storage. Apparatus embodiments provide modules for property determination, treatment application, and parameter regulation. Additional embodiments include computational methods for generating conditioning parameters based on substrate data and methods for regenerating previously used substrates.

### CROSS-REFERENCE TO RELATED APPLICATIONS

This application claims priority to U.S. Provisional Patent Application No. 63/722,731, filed Nov. 20, 2024, titled “Methodology for the Selective Neutralization and Conditioning of Wood Substrates and Moderation of Predominant Wood-Derived Compounds and Flavors to Optimize the Maturation Process of Alcoholic Spirits,” the entirety of which is incorporated herein by reference.

### TECHNICAL FIELD

The disclosure relates to processing lignocellulosic wood substrates and, more particularly, to conditioning treatments that modify extractive composition, diffusion behavior, porosity, surface chemistry, pH buffering characteristics, or related physicochemical properties of wood substrates for controlled interaction with alcoholic beverages during storage or maturation.

### BACKGROUND

Lignocellulosic wood materials such as oak, cherry, maple, chestnut, and acacia are widely used in the storage, aging, and maturation of alcoholic beverages. Commercial practices depend heavily on natural extractives and diffusion pathways within the wood. These materials release tannins, lignin-derived aromatics, hemicellulose breakdown products, esters, and other compounds that influence flavor development.

Traditional cooperage methods rely on bulk wood geometry, passive environmental exposure, torch-based toasting, or manual charring. These approaches provide limited control over extraction kinetics or diffusion pathways. Further, conventional barrels suffer from variability across batches and lack the capacity for fine-tuned control over long-term extraction.

Existing methods also do not adequately address conditioning or regeneration of wood substrates used in alternative systems such as bottle inserts, staves, spiral structures, or micro-processed wood chips. As maturation dynamics evolve with new beverage formats and accelerated extraction technologies, there is a growing need for precise and predictable control over the interaction between lignocellulosic substrates and alcoholic beverages during maturation.

### SUMMARY

In certain embodiments, methods are provided for conditioning a lignocellulosic wood substrate by determining one or more chemical or structural properties of the substrate, applying at least one conditioning treatment (chemical, enzymatic, thermal, or physicochemical), and stabilizing the substrate under controlled environmental conditions to produce predictable extraction behavior when placed in contact with an alcoholic beverage.

In certain embodiments, lignocellulosic wood substrates with modified porosity, extraction kinetics, pH buffering capacity, surface chemistry, or diffusion pathways are described. These substrates may be configured as chips, cubes, staves, spirals, inserts, wafers, veneers, laminates, or other forms.

In certain embodiments, systems include a container holding an alcoholic beverage with a conditioned substrate configured to control flavor development. Apparatus embodiments include modules for determining substrate properties, applying conditioning treatments, and regulating process parameters.

Further embodiments include methods for generating conditioning parameters using computational or machine-learning models based on chemical or structural input data. Methods for regenerating used substrates and kits for aging alcoholic beverages are also described.

### BRIEF DESCRIPTION OF THE DRAWINGS

FIG. 1 is a flowchart depicting a method for conditioning a lignocellulosic wood substrate.

FIG. 2 shows a schematic representation of a lignocellulosic wood substrate having modified properties.

FIG. 3 illustrates an embodiment of a substrate showing cross-sectional or depth-dependent modification and may further illustrate examples of beverages 320, including distilled spirits 322, wine 324, and beer 326, which may be contacted with the conditioned substrate.

FIG. 4 shows a system for maturing alcoholic beverages using a container and conditioned substrate.

FIG. 5 illustrates an apparatus for conditioning lignocellulosic wood substrates, including treatment modules and control systems.

FIG. 6 is a flowchart illustrating a method for generating wood conditioning parameters based on input data.

FIG. 7 is a flowchart illustrating a method for regenerating a used lignocellulosic wood substrate.

FIG. 8 illustrates a kit for aging alcoholic beverages comprising a conditioned substrate and instructions for use.

### DETAILED DESCRIPTION

### Definitions

Lignocellulosic wood substrate: A material containing cellulose, hemicellulose, and lignin derived from natural wood sources including but not limited to oak, cherry, maple, chestnut, acacia, or engineered composites.
Modified extraction kinetics: A change in rate or time profile by which extractive compounds diffuse from the substrate into an alcoholic beverage relative to an untreated substrate.
Modified porosity: An alteration in micro-, meso-, or macro-porous structure of the wood affecting fluid transport or diffusion characteristics.
Modified surface chemistry: A change in functional groups or chemical reactivity of the substrate surface through enzymatic, chemical, or thermal processing.
Conditioning treatment: Any chemical, enzymatic, thermal, physicochemical, or combined treatment applied to modify substrate properties.
Stabilizing: Allowing the substrate to equilibrate under controlled humidity, temperature, or atmospheric conditions after conditioning.

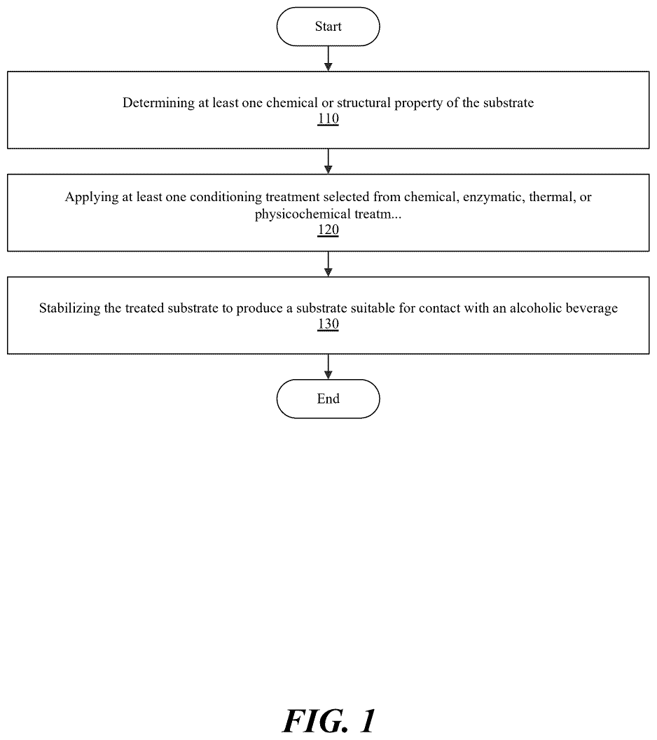

### 1. Conditioning Method (FIG. 1)

FIG. 1 depicts a method including:
1. Determining one or more chemical or structural properties of a lignocellulosic wood substrate (step 110).
2. Applying one or more conditioning treatments (step 120).
3. Stabilizing the substrate under controlled environmental conditions (step 130).

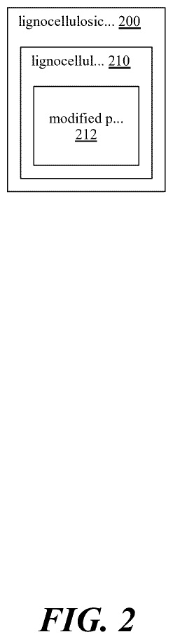

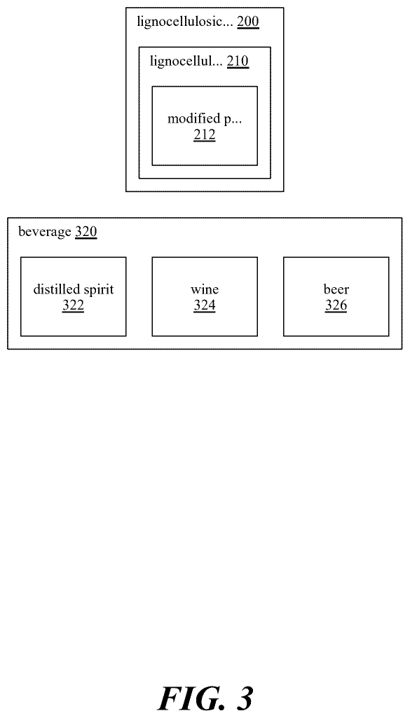

### 2. Conditioned Substrate (FIGS. 2-3)

FIG. 2 shows a substrate 200 with cellulose-lignin matrix 210 and modified property 212.

FIG. 3 illustrates cross-sectional modification including depth-dependent gradients.

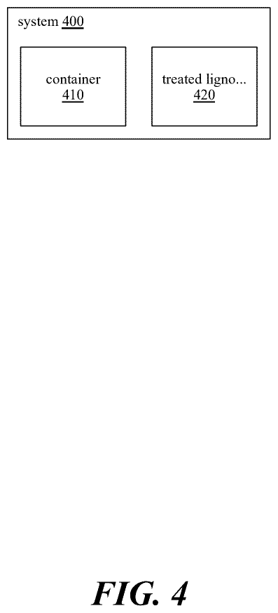

### 3. System for Beverage Maturation (FIG. 4)

FIG. 4 depicts system 400 including container 410 and conditioned substrate 420.

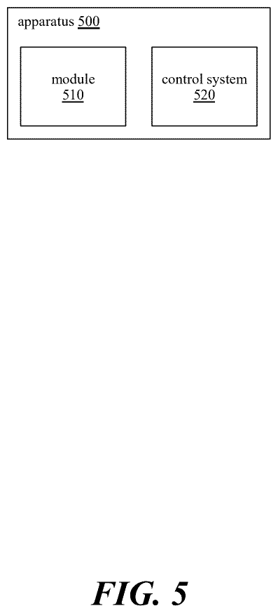

### 4. Conditioning Apparatus (FIG. 5)

FIG. 5 shows apparatus 500 including treatment module 510 and control system 520.

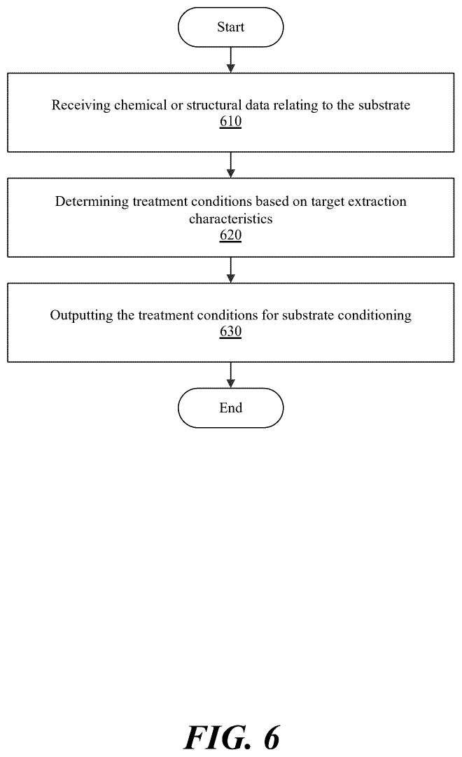

### 5. Parameter Generation (FIG. 6)

FIG. 6 illustrates process 600: receiving data 610, determining treatment conditions 620, and outputting parameters 630.

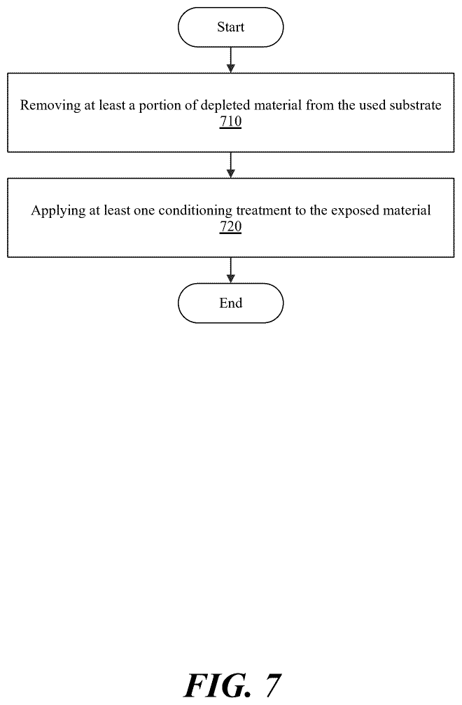

### 6. Regeneration Method (FIG. 7)

FIG. 7 illustrates method 700: removing depleted material 710 and applying conditioning treatment 720.

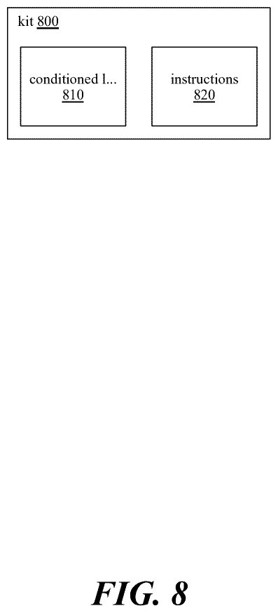

### 7. Kit (FIG. 8)

FIG. 8 shows kit 800 including conditioned substrate 810 and instructions 820.

### ENABLING EXAMPLES

### Example 1: Enzymatic Conditioning

An oak substrate is analyzed and treated with 0.5% w/v laccase at 40° C. for 30 minutes. After rinsing, the substrate is stabilized at 50% humidity for 72 hours.

### Example 2: Thermal Gradient Conditioning

A substrate is heated at 100° C. for 20 minutes, followed by 160° C. for 15 minutes, forming a depth-dependent gradient.

### Example 3: pH Buffer Conditioning

A maple substrate is immersed in acetate buffer at pH 4.2 for 12 minutes.

### Example 4: Machine-Learning Parameter Generation

Input parameters including porosity, moisture, and density are processed by a trained model producing conditioning parameters.

### Example 5: Regeneration

A used substrate is abraded by 0.3 mm, then reconditioned enzymatically and thermally. Extractive behavior is restored within 15-20% of new.

What is claimed is:

1. A method for conditioning a lignocellulosic wood substrate to control extraction behavior during maturation of alcoholic beverages, the method comprising:
determining at least one chemical or structural property of the substrate;
applying at least one conditioning treatment selected from chemical, enzymatic, thermal, or physicochemical treatments, or combinations thereof, in an amount effective to modify extractive composition or diffusion characteristics of the substrate; and
stabilizing the treated substrate to produce a substrate suitable for contact with an alcoholic beverage.

2. A lignocellulosic wood substrate for beverage maturation, comprising:
a lignocellulosic material having at least one modified property selected from modified porosity, modified extraction kinetics, modified pH buffering capacity, modified surface chemistry, or combinations thereof,
wherein the modification alters extractive composition or diffusion behavior relative to untreated wood.

3. A system for maturing alcoholic beverages, comprising:
a container holding an alcoholic beverage; and
a treated lignocellulosic wood substrate according to claim 2,
wherein the substrate alters flavor development during storage.

4. An apparatus for conditioning lignocellulosic wood substrates, comprising:
at least one module configured to apply conditioning treatments to the substrates; and
at least one control system configured to regulate treatment parameters.

5. An alcoholic beverage produced by contacting the beverage with the substrate of claim 2 for a period sufficient to alter extractive composition relative to contact with untreated wood.

6. A method for generating conditioning parameters for modifying a lignocellulosic wood substrate, comprising: receiving chemical or structural data relating to the substrate; determining treatment conditions based on target extraction characteristics; and outputting the treatment conditions for substrate conditioning.

7. A method of regenerating a used lignocellulosic wood substrate, comprising: removing at least a portion of depleted material from the used substrate; and applying at least one conditioning treatment to the exposed material.

8. A kit for aging alcoholic beverages, comprising: at least one conditioned lignocellulosic wood substrate; and instructions for use with an alcoholic beverage.

9. The method of claim 1, wherein the lignocellulosic wood substrate comprises oak, cherry, maple, chestnut, acacia, or combinations thereof.

10. The method of claim 1, wherein applying the conditioning treatment comprises enzymatic treatment.

11. The method of claim 10, wherein the enzyme comprises laccase, cellulase, pectinase, or combinations thereof.

12. The method of claim 1, wherein applying the conditioning treatment comprises pH modification using an aqueous buffer.

13. The method of claim 1, wherein applying the conditioning treatment comprises thermal processing at multiple temperature zones.

14. The method of claim 1, wherein applying the conditioning treatment comprises chemical modification selected from acetylation, oxidation, or combinations thereof.

15. The method of claim 1, wherein the alcoholic beverage has an alcohol concentration of 5% to 70% by volume.

16. The method of claim 1, wherein stabilizing comprises maintaining controlled temperature, humidity, and atmospheric conditions.

17. The method of claim 1, further comprising projecting extraction behavior using a mathematical or computational model.

18. The substrate of claim 2, configured as chips, cubes, staves, spirals, inserts, or combinations thereof.

19. The substrate of claim 2, wherein the modified extraction kinetics reduce tannin extraction relative to untreated wood while preserving extraction of aromatic compounds.

20. The system of claim 3, wherein the container is a sealed bottle.

21. The system of claim 3, wherein the alcoholic beverage comprises tequila, mezcal, whiskey, rum, brandy, or a distilled spirit.

22. The apparatus of claim 4, further comprising analytical instrumentation configured to determine wood substrate properties.

23. The apparatus of claim 4, configured to implement continuous processing of wood substrates.

24. The alcoholic beverage of claim 5, wherein the beverage comprises a distilled spirit, wine, or beer.

25. The method of claim 6, wherein determining treatment conditions comprises applying a machine learning algorithm trained on extraction or diffusion data.

26. The method of claim 7, further comprising analyzing the exposed wood surface prior to conditioning.

27. The method of claim 7, further comprising validating the regenerated substrate using an extraction test.

28. The kit of claim 8, wherein the wood substrate is dimensioned for insertion into a bottle.

29. The method of claim 1, wherein the conditioning treatment creates a gradient of modification through the depth of the substrate.

30. The method of claim 1, wherein the conditioning treatment enables prediction of extraction behavior using a computational model.
